(19) United States
(12) Patent Application Publication
(10) Pub. No.: US 2026/0366932 A1
(43) Pub. Date: Nov. 19, 2026

(54) STRETCHABLE PRESSURE SENSOR ARRAY AND MANUFACTURING METHOD THEREOF

(71) Applicant: SEOUL NATIONAL UNIVERSITY R&DB FOUNDATION, Seoul (KR)

(72) Inventors: Yong Taek HONG, Seoul (KR); Ji Seok SEO, Seoul (KR); Han Ul KIM, Seoul (KR)

(73) Assignee: SEOUL NATIONAL UNIVERSITY R&DB FOUNDATION, Seoul (KR)

(21) Appl. No.: 19/143,107

(22) PCT Filed: Mar. 7, 2023
(86) PCT No.: PCT/KR2023/003091

§ 371 Date: Jun. 25, 2025

(30) Foreign Application Priority Data
Jan. 19, 2023 (KR) 10-2023-0007771

(51) Int. Cl. G01L 1/12; G01L 5/00; G01L 5/169; G06F 3/041

(52) U.S. Cl. CPC G01L 1/12; G01L 5/0033; G01L 5/169; G06F 3/0412

(57) ABSTRACT

The present invention relates to a stretchable pressure sensor array, comprising: a stretchable substrate including an upper surface and a lower surface; a plurality of pressure sensors arranged on the stretchable substrate to form an array structure; an upper electrode formed to be electrically connectable to at least one upper side of the plurality of pressure sensors; a lower electrode formed to be electrically connectable to at least one lower side of the plurality of pressure sensors; and a plurality of stress control parts arranged at the same positions as the plurality of pressure sensors and formed to cover at least one of the upper or lower sides of the plurality of pressure sensors, wherein the stress control parts have a Young's modulus greater than that of the stretchable substrate.

### TECHNICAL FIELD

The present invention relates to a stretchable pressure sensor array, and more particularly, to a stretchable pressure sensor array capable of excluding stress induced by tension by distinguishing between a portion induced by tension and a portion induced by external force.

The present invention also relates to a method for manufacturing the stretchable pressure sensor array.

### BACKGROUND ART

With the development of mobile communication technology, the era of smartphones has arrived following the widespread use of personal computers, and research on electronic devices equipped with flexible next-generation displays such as wearable or stretchable devices has been gradually progressing.

These displays are generally operated by a touch input method, and for this purpose, a pressure sensor is typically provided. Here, a pressure sensor refers to an electronic device capable of sensing an external force, wherein the structure is changed by a force applied from the outside, thereby inducing a change in electrical characteristics.

In order to be applied to wearable or stretchable devices, the pressure sensor needs to have flexible characteristics that allow it to bend well, and for this purpose, a method of forming a pressure sensor on a stretchable substrate is mainly used.

However, when a pressure sensor is formed on such a stretchable substrate, in addition to the case where a change in electrical characteristics is induced by an external force in the thickness direction, the structure of the pressure sensor may also change when the stretchable substrate is stretched, thereby inducing a change in electrical characteristics. Thus, there is a problem in that it is not possible to distinguish between the portion induced by tension and the portion induced by external force.

### DISCLOSURE OF INVENTION

### Problem to be Solved

The object of the present invention is to provide a stretchable pressure sensor array and a method for manufacturing the same, which solve the problem in the prior art of being unable to distinguish between a portion induced by tension and a portion induced by external force.

More specifically, the present invention provides a stretchable pressure sensor array and a method for manufacturing the same, which are capable of excluding a change in electrical characteristics caused by a tensile force acting in a planar direction perpendicular to the thickness direction of the substrate.

### Means for Solving the Problem

In order to solve the above-described problem, a stretchable pressure sensor array according to one aspect of the present invention provides: a stretchable substrate including an upper surface and a lower surface; a plurality of pressure sensors arranged on the stretchable substrate to form an array structure; a first electrode electrically connected to a first pressure sensor group consisting of some of the plurality of pressure sensors; a second electrode electrically connected to a second pressure sensor group, which includes at least one pressure sensor different from those in the first pressure sensor group, among the plurality of pressure sensors; and a plurality of stress control parts arranged at the same positions as the plurality of pressure sensors and formed to cover at least one of an upper side and a lower side of the plurality of pressure sensors, wherein the stress control parts have a Young's modulus greater than that of the stretchable substrate.

According to one embodiment, (i) the first electrode may be formed on the upper surface side of the stretchable substrate and the second electrode may be formed on the lower surface side of the stretchable substrate, or (ii) both the first electrode and the second electrode may be formed on the same one surface side of the stretchable substrate, and at least some of the plurality of pressure sensors may be positioned between the first electrode and the second electrode.

According to one embodiment, when viewed in the thickness direction, the cross-sectional area of the stress control part may be greater than the cross-sectional area of the pressure sensor.

According to one embodiment, at least a portion of the stress control part may be bonded to a portion of the stretchable substrate.

According to one embodiment, the interface between the stress control part and the stretchable substrate may be surface-treated.

According to one embodiment, the stress control part may be made of any one of an epoxy resin, an elastomer, and a plastic.

According to one embodiment, the plastic may be any one of a silicone resin, polyurethane (PU), polyimide (PI), and polyethylene terephthalate (PET).

According to one embodiment, when the relative current change amount (ΔI/I₀) is measured while the stretchable substrate is stretched in a direction perpendicular to the thickness direction under a predetermined pressure in a pressure range of 0 kPa to 180 kPa, the relative current change amount at the predetermined pressure may exhibit a deviation of 10% or less within a strain range of 0 to 20%.

According to one embodiment, in the pressure range of 20 kPa to 100 kPa, the deviation may be 5% or less.

According to one embodiment, each of the plurality of pressure sensors may include a conductive pillar formed by aligning magnetic particles in the thickness direction of the stretchable substrate.

According to one embodiment, the stress control part may be formed to cover at least a portion of the upper electrode or the lower electrode.

According to one embodiment, when pressure is applied in the thickness direction from the upper surface or the lower surface of the stretchable substrate, a conductive path connecting the upper electrode, the pressure sensor, and the lower electrode may be formed so that current flows.

According to one embodiment, the upper electrode and the lower electrode may be provided in plural, and each of the upper electrode and the lower electrode may be formed in a structure that crosses each other at a predetermined pressure sensor position when viewed in the thickness direction.

Another aspect of the present invention provides an electronic device comprising: a cover glass; a display panel disposed below the cover glass; and the above-described stretchable pressure sensor array disposed below the display panel.

Another aspect of the present invention provides a method of manufacturing a stretchable pressure sensor array, comprising: preparing a stretchable substrate on which a plurality of pressure sensors are arranged to form an array structure; forming an upper electrode on an upper surface of the stretchable substrate and forming a lower electrode on a lower surface thereof; and forming stress control parts made of a material having a higher Young's modulus than that of the stretchable substrate on at least one of the upper surface and the lower surface of the stretchable substrate in alignment with each of the plurality of pressure sensors.

Another aspect of the present invention provides a method of manufacturing a stretchable pressure sensor array, comprising: preparing a stretchable substrate; forming a lower electrode on an upper surface of the stretchable substrate; forming a plurality of pressure sensors on the lower electrode; forming an upper electrode above the plurality of pressure sensors; and forming stress control parts made of a material having a higher Young's modulus than that of the stretchable substrate on the upper surface side of the stretchable substrate in alignment with each of the plurality of pressure sensors.

According to one embodiment, the material having a higher Young's modulus may be an epoxy resin, and the step of forming the stress control parts may include a step of patterning the epoxy resin in a liquid state and then curing it.

According to one embodiment, prior to the step of forming the stress control parts, the method may further include a step of surface-treating a portion where the stress control parts are to be formed.

According to one embodiment, the stress control parts may be formed by any one of a printing method; a bar coating method; a transfer method in which the parts are formed on a carrier substrate and then transferred to the stretchable substrate; and a method of directly attaching plastic.

According to one embodiment, the stress control parts may be formed to have a cross-sectional area larger than that of the conductive pillar when viewed in the thickness direction.

### Effect of the Invention

According to the stretchable pressure sensor array of the present invention, even when the stretchable substrate is deformed up to 20% strain by a tensile force acting in a direction perpendicular to the thickness direction, there is an advantageous effect in that the electrical characteristics of the pressure sensors formed on the stretchable substrate substantially do not change.

More specifically, when the relative current change amount (ΔI/I₀) is measured while the stretchable substrate is stretched up to 20% in a direction perpendicular to the thickness direction under a predetermined pressure within a pressure range of 0 kPa to 180 kPa, the relative current change amount at the predetermined pressure exhibits only a deviation of 10% or less within the strain range of 0 to 20%.

Furthermore, in the pressure range of 20 kPa to 100 kPa, the deviation becomes even smaller, exhibiting a deviation of 5% or less.

Due to such characteristics, the stretchable pressure sensor array according to the present invention can be advantageously used for delivering a user's input signal when applied to a stretchable display requiring a stretchable input device. In addition, since the stretchable pressure sensor array according to the present invention can be stretched and attached to a curved surface, it can be advantageously used in input devices for automotive electronic components having many curved surfaces or in wearable healthcare electronic devices that are attached to the human body.

### BRIEF DESCRIPTION OF DRAWINGS

FIG. 1 and FIG. 2 are schematic diagrams showing the general structure of a stretchable pressure sensor array according to the present invention including a structure for controlling stress caused by tension. FIG. 1 shows the state before the substrate is stretched, and FIG. 2 shows the state after the substrate is stretched.

FIG. 3 is a photograph of an actually fabricated stretchable pressure sensor array according to the present invention, showing the states at 0% strain, 10% strain, and 20% strain, respectively.

FIG. 4 is a graph showing the change in electrical characteristics of the stretchable pressure sensor array according to the present invention.

### DETAILED DESCRIPTION OF THE INVENTION

The embodiments of the present invention are provided for illustrative purposes to explain the technical spirit of the present invention. The scope of rights according to the present invention is not limited to the embodiments described below or the specific descriptions thereof.

All technical and scientific terms used in the present invention, unless otherwise defined, have meanings generally understood by those skilled in the art to which the present invention pertains.

All terms used in the present invention are selected for the purpose of clearly describing the present invention and are not intended to limit the scope of rights according to the present invention.

Expressions such as “comprising,” “including,” and “having” used in the present invention are to be understood as open-ended terms that imply the possibility of including other embodiments, unless otherwise stated in the phrase or sentence in which they appear.

Singular expressions described in the present invention are to be interpreted as including the plural, unless otherwise specified, and the same applies to the singular expressions described in the claims.

In the present invention, the thickness direction of the substrate is defined as the z-axis direction, the x-axis direction is defined as an arbitrary direction perpendicular to the z-axis direction, and the y-axis direction is defined as a direction perpendicular to both the x-axis and z-axis directions.

Hereinafter, embodiments of the present invention will be described with reference to the accompanying drawings. In the following description of the embodiments, redundant descriptions of identical or corresponding components may be omitted. However, even if the description of a component is omitted, it is not intended to mean that such a component is not included in a particular embodiment.

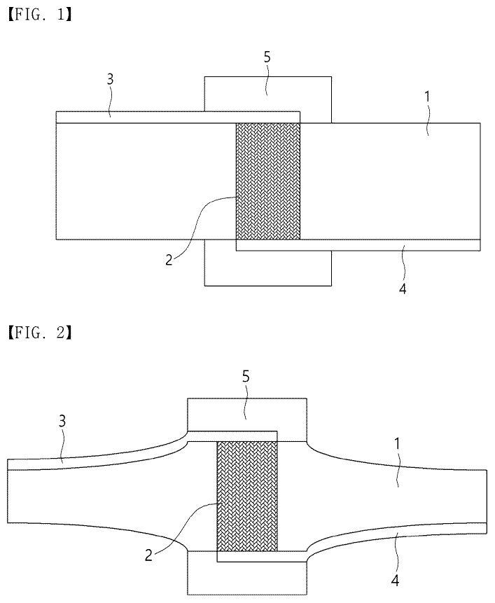

First, with reference to FIG. 1 and FIG. 2, the structure of a stretchable pressure sensor array according to one aspect of the present invention will be described in detail.

The stretchable pressure sensor array proposed in one aspect of the present invention includes: a stretchable substrate including an upper surface and a lower surface; a plurality of pressure sensors arranged on the stretchable substrate to form an array structure; a first electrode electrically connected to a first pressure sensor group consisting of some of the plurality of pressure sensors; a second electrode electrically connected to a second pressure sensor group including at least one pressure sensor different from those in the first pressure sensor group among the plurality of pressure sensors; and a plurality of stress control parts arranged at the same positions as the plurality of pressure sensors and formed to cover at least one of an upper side and a lower side of the plurality of pressure sensors, wherein the stress control parts have a Young's modulus greater than that of the stretchable substrate.

According to one embodiment, (i) the first electrode may be formed on the upper surface side of the stretchable substrate and the second electrode may be formed on the lower surface side of the stretchable substrate, or (ii) both the first electrode and the second electrode may be formed on the same one surface side of the stretchable substrate, and at least some of the plurality of pressure sensors may be positioned between the first electrode and the second electrode.

In a more specific example, the stretchable pressure sensor array may include: a stretchable substrate (1) including an upper surface and a lower surface; a plurality of pressure sensors (2) arranged on the stretchable substrate (1) to form an array structure; an upper electrode (3) formed on the upper surface of the stretchable substrate (1); a lower electrode (4) formed on the lower surface of the stretchable substrate (1); and a plurality of stress control parts (5) arranged at the same positions as the plurality of pressure sensors (2) and formed to cover at least one of the upper side and the lower side of the plurality of pressure sensors (2).

The stress control parts (5) may have a Young's modulus greater than that of the stretchable substrate (1).

In this embodiment, the upper electrode may correspond to the first electrode, and the lower electrode may correspond to the second electrode.

FIG. 1 and FIG. 2 are schematic diagrams showing the general structure of a stretchable pressure sensor array (2) according to one aspect of the present invention. FIG. 1 is a cross-sectional view showing a state before a tensile force is applied to the stretchable substrate (1), and FIG. 2 is a cross-sectional view showing a state in which the stretchable substrate (1) is stretched by applying tensile forces in the x-axis and γ-axis directions.

The stretchable pressure sensor array according to one aspect of the present invention includes a stretchable substrate (1) having an upper surface and a lower surface. The material of the stretchable substrate (1) is not particularly limited in the present invention, but it is preferable that the base material of the stretchable substrate (1) be formed of a polymer material exhibiting flexibility. The dimensions such as the size and height of the substrate, and other properties, are not particularly limited except for the stretchable property. When the stretchable pressure sensor array is used in an image output device such as a display, it is preferable that it be made of a transparent material.

The stretchable substrate (1) may include an elastomer to provide flexibility. In a non-limiting embodiment, the elastomer may include one or more selected from the group consisting of: a substituted or unsubstituted polyorganosiloxane, an elastomer including a substituted or unsubstituted butadiene moiety, an elastomer including a urethane moiety, an elastomer including an acryl moiety, an elastomer including an olefin moiety, and combinations thereof. In another non-limiting embodiment, the elastomer may be formed to include a PDMS material.

As shown in FIG. 1, pressure sensors (2) are formed in the stretchable substrate (1). In FIG. 1, the entire pressure sensor (2) is embedded in the stretchable substrate (1), but the invention is not limited thereto; only a portion of the pressure sensor (2) may be embedded, or the pressure sensor (2) may be formed on the surface of the stretchable substrate (1). Although FIG. 1 illustratively shows only one pressure sensor (2), the stretchable pressure sensor array according to one aspect of the present invention includes a plurality of pressure sensors (2), and the plurality of pressure sensors (2) may be arranged on the stretchable substrate (1) to form an array structure. The plurality of pressure sensors (2) may be regularly arranged or irregularly arranged, depending on the need.

The plurality of pressure sensors (2) may be provided as separate components embedded or inserted into the stretchable substrate (1), or may be provided in an embedded configuration within the substrate as conductive pillars formed by agglomeration of magnetic particles aligned in the thickness direction of the substrate.

In a non-limiting embodiment, the magnetic particles may include ferromagnetic particles or aggregates thereof. The magnetic particles may include ferromagnetic material particles. The magnetic particles may be embedded within an elastomer included in the stretchable substrate. The magnetic particles may have an average particle diameter ranging from several nanometers to several tens of micrometers, preferably from about 3 nm to less than 100 μm, more preferably from about 5 nm to 80 μm, and even more preferably from about 10 nm to 50 μm, although not limited thereto.

In a non-limiting embodiment, the magnetic particles may include metal particles selected from nickel, cobalt, iron, manganese, alloys thereof, or combinations thereof.

In a non-limiting embodiment, the conductive pillar may further include one or more selected from conductive nanowires, conductive nanotubes, conductive nanorods, conductive nanofibers, or combinations thereof.

In another non-limiting embodiment, the conductive pillar may further include conductive nanostructures. The conductive nanostructures may be materials capable of exhibiting resistance changes in response to external forces. The conductive nanostructures may include low-resistance metals. The conductive nanostructures may be linear conductive nanostructures, and may include, for example, conductive nanowires, conductive nanotubes, conductive nanorods, conductive nanofibers, or combinations thereof. Alternatively, the conductive nanostructures may be silver (Ag) nanowires.

As shown in FIG. 1, an upper electrode (3) may be formed on the upper surface of the stretchable substrate (1), and a lower electrode (4) may be formed on the lower surface. The upper electrode (3) and the lower electrode (4) may also have flexibility, similar to the stretchable substrate.

The upper electrode (3) and the lower electrode (4) may each be provided in plural, and each of the upper electrode (3) and the lower electrode (4) may be formed in a structure that intersects each other when viewed in the thickness direction. At the intersection points of the upper electrode (3) and the lower electrode (4), a pressure sensor (2) is positioned between the upper and lower electrodes. Accordingly, when pressure is applied in the thickness direction from the upper or lower surface of the stretchable substrate (1), a conduction path extending through the upper electrode (3), the pressure sensor (2), and the lower electrode (4) may be formed.

Each of these intersection points may constitute a unit pixel of the stretchable pressure sensor array according to one aspect of the present invention.

In a non-limiting embodiment, the first electrode (upper electrode (3)) and the second electrode (lower electrode (4)) may be formed on the same side of the stretchable substrate (1). For example, both the first electrode (3) and the second electrode (4) may be formed on the upper surface side of the stretchable substrate (1), or both may be formed on the lower surface side. In this case as well, the pressure sensor (2) is interposed between the upper electrode (3) and the lower electrode (4).

The spacing between adjacent upper electrodes (3) and the spacing between adjacent lower electrodes (4) are not particularly limited, but the finer the spacing, the higher the spatial resolution of the pressure sensors (2) may be. In a non-limiting embodiment, the plurality of upper electrodes (3), the plurality of lower electrodes (4), or both may have an interval of 0.1 mm to 5 mm between adjacent electrodes.

In a non-limiting embodiment, the upper electrode (3), the lower electrode (4), or both may be partially embedded in the stretchable substrate (1).

The stretchable pressure sensor array according to one aspect of the present invention includes a plurality of stress control parts (5) arranged at the same positions as the plurality of pressure sensors (2). Depending on the desired degree of protection against tensile stress, the stress control parts (5) may be formed on only one of the upper or lower sides of the pressure sensors (2), or may be formed on both the upper and lower sides. As shown in FIG. 1, the stress control parts (5) may be formed to cover at least a portion of the upper electrode (3) or the lower electrode (4).

The stress control parts (5) may have a Young's modulus greater than that of the stretchable substrate (1). Because the stress control parts (5) have a high Young's modulus, they allow structural deformation when pressure is applied in the thickness direction, but restrict structural deformation when pulled laterally. Through this, portions induced by tension can be suppressed, while portions induced by external force can be maintained. In other words, as shown in FIG. 2, when the stretchable substrate (1) is stretched laterally, the lateral structural deformation of the stress control part (5) is restricted, so there is little or no change in the area where the stress control part (5) is attached. As a result, the pressure sensor (2) is not affected by the portion induced by tension.

The Young's modulus of the stress control part (5) is sufficient as long as it is greater than that of the stretchable substrate (1), and therefore its exact value is not particularly limited. However, in a non-limiting embodiment, the Young's modulus may be 1.6 GPa or more, and preferably 2.3 GPa or more. The stress control part (5) may be made of a material having a high Young's modulus, and for example, may be formed from any one of epoxy resin, elastomer, or plastic. In the case of plastic, any one of silicone resin, polyurethane (PU), polyimide (PI), and polyethylene terephthalate (PET) may be used.

In a non-limiting embodiment, when viewed in the thickness direction, the cross-sectional area of the stress control part (5) may be greater than the cross-sectional area of the pressure sensor (2). Accordingly, as shown in FIG. 1, the stress control part (5) may completely cover the pressure sensor (2), and at least a portion of the stress control part (5) may be bonded to a portion of the stretchable substrate (1).

In a non-limiting embodiment, the stress control part (5) may be formed to cover at least a portion of the upper electrode (3) or the lower electrode (4).

In a non-limiting embodiment, the interface where the stress control part (5) and the stretchable substrate (1) are bonded may be surface-treated to enhance the bonding strength between them. The surface treatment method is not particularly limited, and any method capable of improving the bonding strength may be applied to the present invention without limitation. In a non-limiting embodiment, the surface treatment may be plasma treatment, or a treatment using a surface modifier such as 3-Aminopropyltriethoxysilane (APTES), which can chemically bond with the material forming the stress control part (5).

Another aspect of the present invention provides an electronic device including the stretchable pressure sensor array according to one aspect of the present invention. The electronic device includes: a cover glass; a display panel disposed below the cover glass; and the stretchable pressure sensor array disposed below the display panel and comprising the above-described configuration.

Next, a method for manufacturing the stretchable pressure sensor array according to the present invention will be described. However, the manufacturing method described below is merely one example among various possible methods for fabricating the stretchable pressure sensor array according to one aspect of the present invention.

First, a stretchable substrate (1) in which a plurality of pressure sensors (2) are arranged to form an array structure is prepared. The method of forming the plurality of pressure sensors (2) on the stretchable substrate (1) is not particularly limited and may utilize known techniques.

Next, an upper electrode (3) is formed on the upper surface of the stretchable substrate (1), and a lower electrode (4) is formed on the lower surface. The present invention does not particularly limit the method of forming the electrodes. In a non-limiting embodiment, the upper electrode (3) and the lower electrode (4) may be formed by spray coating, by directly performing a solution process on the upper and lower surfaces of the stretchable sheet, or by attaching pre-formed electrodes.

In a non-limiting embodiment, a stretchable substrate (1) without pressure sensors (2) may be prepared, and the lower electrode (4), pressure sensors (2), and upper electrode (3) may be sequentially laminated and formed on the upper surface of the stretchable substrate (1).

Subsequently, stress control parts (5) made of a material having a higher Young's modulus than that of the stretchable substrate (1) are formed in alignment with each of the plurality of pressure sensors (2) on at least one of the upper surface and the lower surface of the stretchable substrate (1).

The method for forming the stress control parts (5) may vary depending on the material used. Depending on the characteristics of the material, the stress control parts (5) may be formed using a printing method, a bar coating method, a transfer method in which the parts are first formed on a carrier substrate and then transferred to the stretchable substrate (1), or a method of directly attaching a plastic material such as PET.

For example, if the material having a high Young's modulus is an epoxy resin, the stress control parts may be formed by patterning the epoxy resin in a liquid state on the stretchable substrate (1), and then curing it using heat or ultraviolet (UV) light.

Optionally, prior to forming the stress control parts (5), a surface treatment step may be additionally performed on the portions where the stress control parts (5) are to be formed. In a non-limiting embodiment, the surface treatment may be plasma treatment, or a treatment using a surface modifier such as 3-Aminopropyltriethoxysilane (APTES), which can chemically bond with the material forming the stress control parts (5).

### Examples of Embodiment

First, a stretchable substrate (1) in which pressure sensors (2) are arranged at regular intervals was prepared. Then, AgNW electrodes were embedded on both the upper and lower surfaces of the stretchable substrate (1), arranged such that they intersect at predetermined pressure sensor (2) positions. Subsequently, in alignment with each of the plurality of pressure sensors (2), an epoxy resin was patterned on the upper and lower surfaces of the stretchable substrate (1) and cured using UV light to form the stress control parts (5).

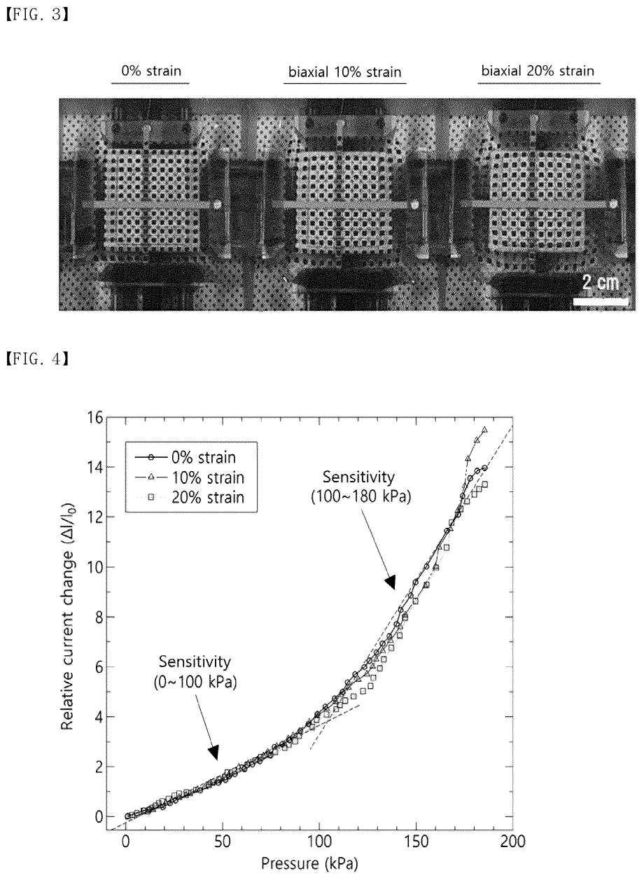

FIG. 3 is a photograph of an actually fabricated stretchable pressure sensor array according to the present invention, showing the states at 0% strain, 10% strain, and 20% strain, respectively.

FIG. 4 is a graph showing the change in electrical characteristics of the stretchable pressure sensor array according to the present invention.

Next, as shown in FIG. 3, a biaxial tensile tester was used to stretch the stretchable substrate (1) in the x-axis and γ-axis directions, and the relative current change (ΔI/I₀) under a predetermined pressure was measured. The results are shown in Table 1 and FIG. 4.

TABLE 1

| | Relative Current Change (ΔI/I₀) | | | Maximum |
|---|---|---|---|---|
| Pressure(kPa) | 0% strain | 10% strain | 20% strain | Deviation |
| 10 | 0.23976 | 0.22141 | 0.22548 | 5.96% |
| 30 | 0.88581 | 0.8824 | 0.91497 | 3.29% |
| 50 | 1.5163 | 1.53977 | 1.58867 | 4.77% |
| 70 | 2.41425 | 2.44893 | 2.36544 | 1.44% |
| 90 | 3.29337 | 3.39514 | 3.20469 | 3.09% |
| 100 | 4.13363 | 4.0716 | 3.84348 | 1.50% |
| 150 | 9.37277 | 8.63274 | 8.612 | 7.90% |
| 180 | 13.83183 | 15.05325 | 12.87154 | 8.83% |

As a result of the experiment, it was confirmed that when the relative current change (ΔI/I₀) was measured while increasing the tensile range within a pressure range of 0 to 180 kPa, the change in relative current remained within a deviation of 10% or less. In addition, within the pressure range of 20 to 100 kPa, the deviation was further reduced to 5% or less. From these results, it can be confirmed that in the case of the stretchable pressure sensor array according to the present invention, even when biaxially stretched (in the x-axis and γ-axis directions) up to 20%, the change in electrical characteristics is extremely small.

The above description is merely illustrative of the technical spirit of the present invention. Those skilled in the art to which the invention pertains will understand that various modifications and changes can be made without departing from the essential characteristics of the invention. Therefore, the embodiments disclosed herein are not intended to limit the technical spirit of the present invention but to explain it, and the scope of the technical spirit of the present invention is not limited by these embodiments.

The scope of protection of the present invention shall be interpreted based on the following claims, and all technical ideas within the equivalent scope thereof shall be interpreted as being included within the scope of rights of the present invention.

### DESCRIPTION OF REFERENCE NUMERALS

1: Stretchable substrate
2: Pressure sensor
3: Upper electrode
4: Lower electrode
5: Stress control part

1. A stretchable pressure sensor array comprising:
a stretchable substrate including an upper surface and a lower surface;
a plurality of pressure sensors arranged on the stretchable substrate to form an array structure;
a first electrode electrically connected to a first pressure sensor group consisting of some of the plurality of pressure sensors;
a second electrode electrically connected to a second pressure sensor group including at least one pressure sensor different from those in the first pressure sensor group among the plurality of pressure sensors; and
a plurality of stress control parts arranged at the same positions as the plurality of pressure sensors and formed to cover at least one of an upper side and a lower side of the plurality of pressure sensors,
wherein the stress control parts have a Young's modulus greater than that of the stretchable substrate.

2. The stretchable pressure sensor array of claim 1,
wherein
(i) the first electrode is formed on the upper surface side of the stretchable substrate and the second electrode is formed on the lower surface side of the stretchable substrate, or
(ii) both the first electrode and the second electrode are formed on the same one surface side of the stretchable substrate,
and at least some of the plurality of pressure sensors are positioned between the first electrode and the second electrode.

3. The stretchable pressure sensor array according to claim 1,
wherein, when viewed in the thickness direction, the cross-sectional area of the stress control part is greater than the cross-sectional area of the pressure sensor.

4. The stretchable pressure sensor array according to claim 1,
wherein at least a portion of the stress control part is bonded to a portion of the stretchable substrate.

5. The stretchable pressure sensor array according to claim 4, wherein the interface where the stress control part and the stretchable substrate are bonded is surface-treated.

6. The stretchable pressure sensor array according to claim 1,
wherein the stress control part is made of any one of an epoxy resin, an elastomer, and a plastic.

7. The stretchable pressure sensor array according to claim 6, wherein the plastic is any one of silicone resin, polyurethane (PU), polyimide (PI), and polyethylene terephthalate (PET).

8. The stretchable pressure sensor array according to claim 1,
wherein, when the relative current change (ΔI/I₀) is measured while stretching the stretchable substrate in a direction perpendicular to the thickness direction under a predetermined pressure within a pressure range of 0 kPa to 180 kPa, the relative current change at the predetermined pressure exhibits a deviation of 10% or less within a strain range of 0 to 20%.

9. The stretchable pressure sensor array according to claim 8, wherein, in the pressure range of 20 kPa to 100 kPa, the deviation is 5% or less.

10. The stretchable pressure sensor array according to claim 1,
wherein each of the plurality of pressure sensors includes a conductive pillar formed by alignment of magnetic particles in the thickness direction of the stretchable substrate.

11. The stretchable pressure sensor array according to claim 1, wherein the stress control part is formed to cover at least a portion of the upper electrode or the lower electrode.

12. The stretchable pressure sensor array according to claim 11, wherein, when pressure is applied in the thickness direction from the upper surface or the lower surface of the stretchable substrate, a conductive path connecting the upper electrode, the pressure sensor, and the lower electrode is formed so that current flows.

13. The stretchable pressure sensor array according to claim 1,
wherein the upper electrode and the lower electrode are each provided in plurality,
and each of the upper electrode and the lower electrode is formed in a structure that intersects at a predetermined pressure sensor position when viewed in the thickness direction.

14. An electronic device comprising:
a cover glass;
a display panel disposed below the cover glass; and
the stretchable pressure sensor array according to claim 1 disposed below the display panel.

15. A method of manufacturing a stretchable pressure sensor array, comprising:
preparing a stretchable substrate in which a plurality of pressure sensors are arranged to form an array structure;
forming an upper electrode on an upper surface of the stretchable substrate, and forming a lower electrode on a lower surface of the stretchable substrate; and
forming a stress control part made of a material having a higher Young's modulus than that of the stretchable substrate on at least one of the upper surface and the lower surface of the stretchable substrate in alignment with each of the plurality of pressure sensors.

16. A method of manufacturing a stretchable pressure sensor array, comprising:
preparing a stretchable substrate;
forming a lower electrode on an upper surface of the stretchable substrate;
forming a plurality of pressure sensors on the lower electrode;
forming an upper electrode above the plurality of pressure sensors; and
forming a stress control part made of a material having a higher Young's modulus than that of the stretchable substrate on the upper surface side of the stretchable substrate in alignment with each of the plurality of pressure sensors.

17. The method of manufacturing a stretchable pressure sensor array according to claim 15,
wherein the material having a higher Young's modulus is an epoxy resin,
and the step of forming the stress control part includes patterning the epoxy resin in a liquid state and then curing it.

18. The method of manufacturing a stretchable pressure sensor array according to claim 15,
further comprising a step of surface-treating a portion where the stress control part is to be formed, prior to the step of forming the stress control part.

19. The method of manufacturing a stretchable pressure sensor array according to claim 15,
wherein the stress control part is formed by any one method selected from:
a printing method;
a bar coating method;
a transfer method in which the stress control part is formed on a carrier substrate and then transferred to the stretchable substrate; and
a method of directly attaching plastic.

20. The method of manufacturing a stretchable pressure sensor array according to claim 15,
wherein the stress control part is formed to have a cross-sectional area greater than that of the conductive pillar when viewed in the thickness direction.
